(19) United States
(12) Patent Application Publication
(10) Pub. No.: US 2008/0165729 A1
(43) Pub. Date: Jul. 10, 2008

(54) Apparatus and method for allocating network address

(75) Inventors: Seong-Gu Kim, Seoul (KR); Soo-Yeul Oh, Seoul (KR); Zea-Jong Kang, Anyang-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/006,638

(22) Filed: Jan. 4, 2008

(30) Foreign Application Priority Data
Jan. 4, 2007 (KR) 2007-0000900

(51) Int. Cl. H04Q 7/00

(52) U.S. Cl. 370/329

(57) ABSTRACT

An apparatus and method for network address allocation are provided, in which an interface module performs wireless communications through an antenna, and a protocol controller performs wireless communications using a predetermined protocol and performs a network address acquisition procedure during network entry.

### CROSS-REFERENCE TO RELATED APPLICATION(S) AND CLAIM OF PRIORITY

This application claims the benefit under 35 U.S.C. §119(a) of a Korean Patent Application filed in the Korean Intellectual Property Office on Jan. 4, 2007 and assigned Serial No. 2007-0000900, the entire disclosure of which is hereby incorporated by reference.

### TECHNICAL FIELD OF THE INVENTION

The present invention generally relates to network address allocation. More particularly, the present invention relates to an apparatus and method for, when an Internet Protocol (IP) address is allocated by a Dynamic Host Configuration Protocol (DHCP), completing IP address allocation before completion of an operating system (OS) booting by implementing a DHCP client function within a Device Driver (DD) in a Broadband Wireless Access (BWA) communication system.

### BACKGROUND OF THE INVENTION

Providing services with diverse Quality of Service (QoS) requirements at or above 100 Mbps to users is an active study area for a future-generation communication system, called a 4th Generation (4 G) communication system. Particularly, active research is conducted on providing high-speed service by ensuring mobility and QoS to a BWA communication system, such as Wireless Local Area Network (WLAN) and Wireless Metropolitan Area Network (WMAN). Such major examples are BWA communication systems, Institute of Electrical and Electronics Engineers (IEEE) 802.16d and IEEE 802.16e. For Worldwide Interoperability for Microwave Access (WiMAX) or Wireless Broadband (WiBro), the IEEE 802.16d and IEEE 802.16e communication technologies are exploited.

The IEEE 802.16d and IEEE 802.16e communication systems are implemented by applying Orthogonal Frequency Division Multiplexing (OFDM) or Orthogonal Frequency Division Multiple Access (OFDMA) techniques to physical channels. IEEE 802.16d considers only a single-cell structure with no regard to mobility of subscriber stations. In contrast, IEEE 802.16e supports subscriber station mobility.

An IEEE 802.16e-enabled device can be manufactured in the form of a portable terminal, or a Personal Computer Memory Card International Association (PCMCIA) card inserted into an electronic device (e.g., computer).

FIG. 1 is a block diagram of a conventional terminal equipped with an IEEE 802.16e PCMCIA card, for IP address allocation.

Referring to FIG. 1, a PCMCIA card 110 is connected to a computer. An operating system (OS) 130 controls the PCMCIA card 110 through a DD 120 when the computer operates.

After loading the DD 120, the OS 130 can control the PCMCIA card 110 and enters an IEEE 802.16e network during the control operation. When completing booting including the DD loading, the OS 130 activates a DHCP client program 140 and is allocated an IP address by an IP allocation procedure, which will be described below in detail.

FIG. 2 illustrates the IP address allocation procedure in the conventional terminal equipped with the IEEE 802.16e PCMCIA card 110.

Referring to FIG. 2, as stated above, the OS 130 can control the PCMCIA card 110 (hereinafter, referred to as MODEM) after DD loading.

The DD enters the IEEE 802.16e network according to a predetermined value or by user selection in step a). Then the MODEM generates an interrupt indicating the network entry in step b). The DD receives the interrupt in step c) and notifies the OS of the network entry in step d).

The OS controls a network interface to request an IP address to the DHCP client program in step e). Accordingly, the network interface requests the IP address by the DHCP client program in step f).

The DHCP client program is allocated an IP address by a DPCH allocation procedure in steps g) and i) and provides the IP address to the network interface in step k).

The above IP address allocation takes place after booting is completed, inclusive of DD loading. Therefore, the booting time delays IP address acquisition.

The DD is configured so as to enter the network through the MODEM at a random time. The DHCP client program is also set to start at a random time during the IP address allocation procedure, taking into account packet contention at a server end, thus adding to the delay.

Consequently, the IP address acquisition is delayed due to the above delay factors.

### SUMMARY OF THE INVENTION

To address the above-discussed deficiencies of the prior art, it is a primary aspect of exemplary embodiments of the present invention to address at least the problems and/or disadvantages and to provide at least the advantages described below. Accordingly, an aspect of exemplary embodiments of the present invention is to provide an apparatus and method for allocating a network address.

Another aspect of exemplary embodiments of the present invention is to provide an apparatus and method for reducing an IP address allocation time in a BWA communication system.

A further aspect of exemplary embodiments of the present invention is to provide an apparatus and method for reducing an IP address allocation time by starting an IP address allocation procedure immediately after a DD of a PCMCIA card completes network entry in a BWA communication system.

Still another aspect of exemplary embodiments of the present invention is to provide an apparatus and method for reducing the time required to complete a network connection by reducing an IP address allocation time in a BWA communication system.

In accordance with an aspect of exemplary embodiments of the present invention, there is provided an apparatus for network address allocation in a terminal in a BWA communication system, in which an interface module performs wireless communications through an antenna, and a protocol controller performs wireless communications using a predetermined protocol and performs a network address acquisition procedure during network entry.

In accordance with another aspect of exemplary embodiments of the present invention, there is provided a method for network address allocation in a terminal in a BWA communication system, in which network entry is performed by a protocol controller, network address allocation is requested by the protocol controller, after the network entry, a requested network address is allocated to the protocol controller, and the allocated network address is set for a radio communication interface by the protocol controller.

In accordance with a further aspect of exemplary embodiments of the present invention, there is provided a system for network address allocation in a BWA communication system, in which a network device communicates with another node by a predetermined protocol and allocates a network address, upon receipt of a network address allocation request, and a terminal performs wireless communications with the network device by the predetermined protocol and performs a network address acquisition procedure during network entry, through a protocol controller.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a conventional terminal equipped with an IEEE 802.16e PCMCIA card, for IP address allocation;

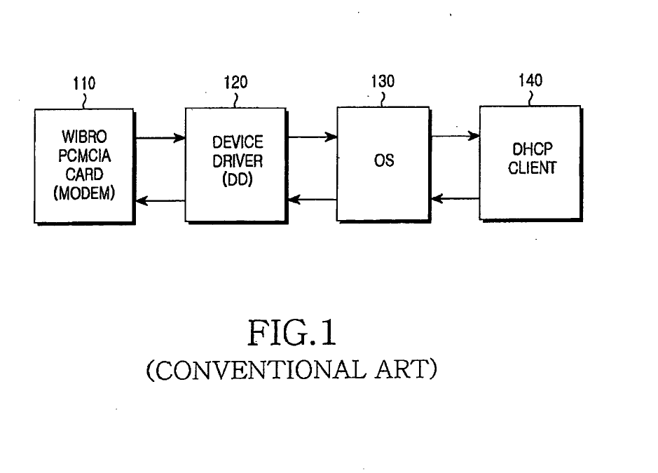

FIG. 2 illustrates an IP address allocation procedure in the conventional terminal equipped with the IEEE 802.16e PCMCIA card;

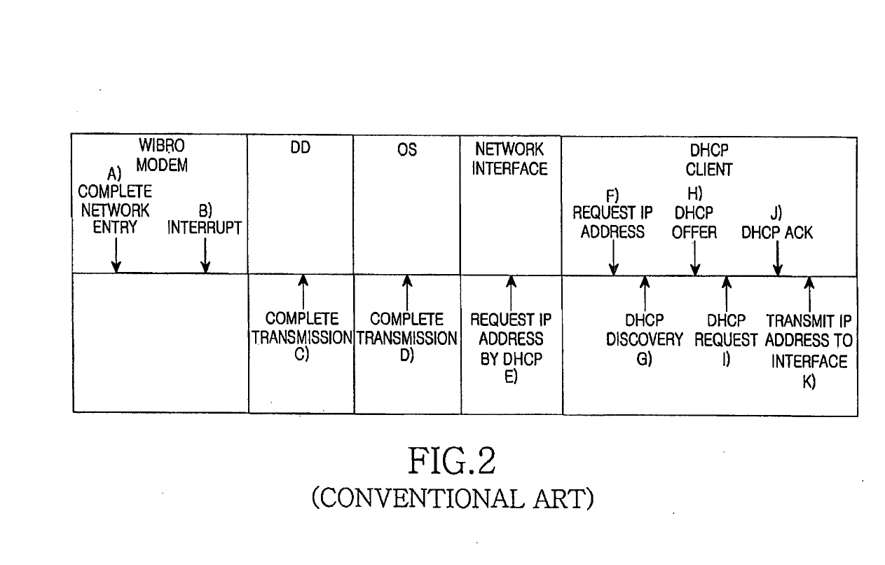

FIG. 3 is a block diagram of a terminal equipped with an IEEE 802.16e PCMCIA card, for IP address allocation according to an exemplary embodiment of the present invention;

FIG. 4 illustrates an IP address allocation procedure in the terminal equipped with the IEEE 802.16e PCMCIA card according to an exemplary embodiment of the present invention;

FIG. 5 is a flowchart of the IP allocation procedure in the terminal equipped with the IEEE 802.16e PCMCIA card according to an exemplary embodiment of the present invention; and

FIG. 6 is a block diagram of an IP address allocation apparatus in the IEEE 802.16e PCMCIA card according to an exemplary embodiment of the present invention.

### DETAILED DESCRIPTION OF THE INVENTION

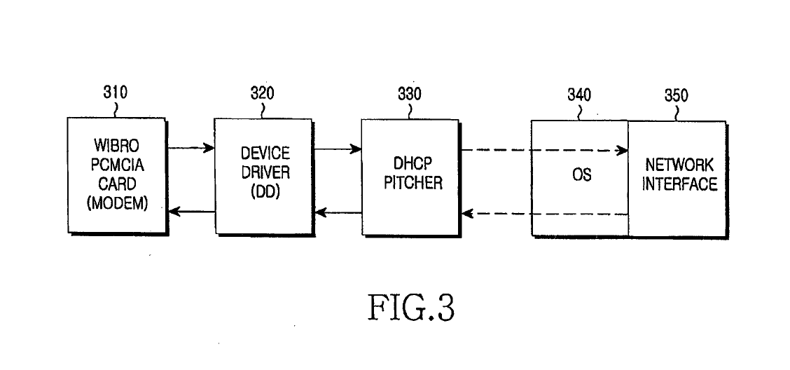

FIGS. 3 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

The present invention is intended to provide an apparatus and method for allocating a network address.

FIG. 3 is a block diagram of a terminal equipped with an IEEE 802.16e PCMCIA card, for IP address allocation according to an exemplary embodiment of the present invention.

Referring to FIG. 3, a MODEM 310 is connected to a computer. When the computer operates, an operating system (OS) 340 controls the MODEM 310 through a DD 320.

The OS 340 loads the DD 320 during booting. The loading also involves loading of a process associated with a network interface 350.

When the DD 320 enters a network by controlling the MODEM 310, it drives its internal processor, a DHCP pitcher 330. The DHCP pitcher 330 performs a DHCP client function, receives an allocated IP address, and provides the ID address to the DD 320.

The DD 320 sets the received IP address as an IP address of the network interface 350. This procedure will be detailed below.

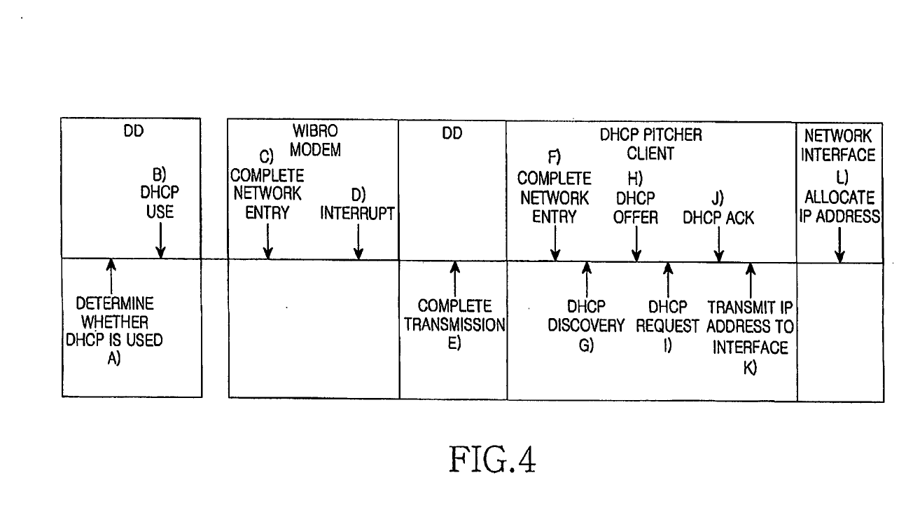

FIG. 4 illustrates the IP address allocation procedure in the terminal equipped with the IEEE 802.16e PCMCIA card according to an exemplary embodiment of the present invention.

Referring to FIG. 4, this procedure starts when a subscriber installs the MODEM on the computer, or the computer is booted and thus the DD is loaded with the MODEM installed.

The DD determines whether the MODEM is set to use the DHCP in step a). If the MODEM is set to use the DHCP, the DD activates the DHCP pitcher in step b).

The DD enters an IEEE 802.16e network according to a predetermined value or by user selection in step c). When the MODEM generates an interrupt indicating the network entry in step d), the DD receives the interrupt in step e) and notifies the DHCP of the network entry in step f).

Then the DHCP pitcher activates the DHCP client function and performs an IP address allocation procedure in steps g) to j). In steps k) and l), the DHCP pitcher provides the IP address to the network interface.

Compared to the conventional technology in which after the computer is completely booted, the OS activates the DHCP client program and receives an allocated IP address by an IP address allocation procedure, the IP address is allocated during the DD loading in the present invention.

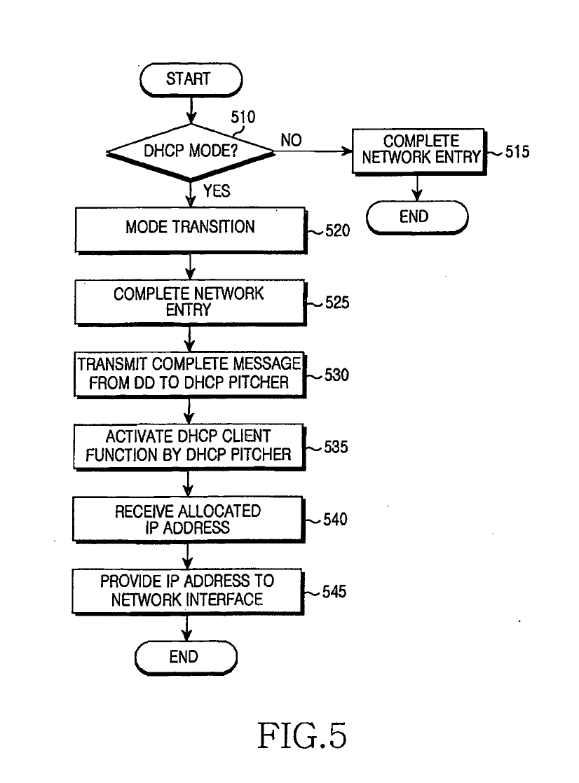

FIG. 5 is a flowchart of the IP allocation procedure in the terminal equipped with the IEEE 802.16e PCMCIA card according to an exemplary embodiment of the present invention.

Referring to FIG. 5, this procedure starts when the subscriber installs the MODEM on the computer, or the computer is booted and thus the DD is loaded with the MODEM installed.

The DD determines whether the MODEM is set to use the DHCP in step 510. If the MODEM is not set to use the DHCP, the DD performs network entry in step 515 and then awaits reception of an instruction from the subscriber or the OS.

If the MODEM is set to use the DHCP, the DD transitions to a DPCH mode by activating the DHCP mode in step 520.

Then the DD enters the IEEE 802.16e network in step 525.

After the network entry, the MODEM generates an interrupt indicating the network entry, and the DD receives the interrupt and notifies the DHCP pitcher of the network entry in step 530.

In step 535, the DHCP pitcher performs an IP address allocation procedure by activating the DHCP client function. The DHCP pitcher receives an allocated IP address in step 540 and provides the allocated IP address to the network interface in step 545.

Then the algorithm of the present invention ends.

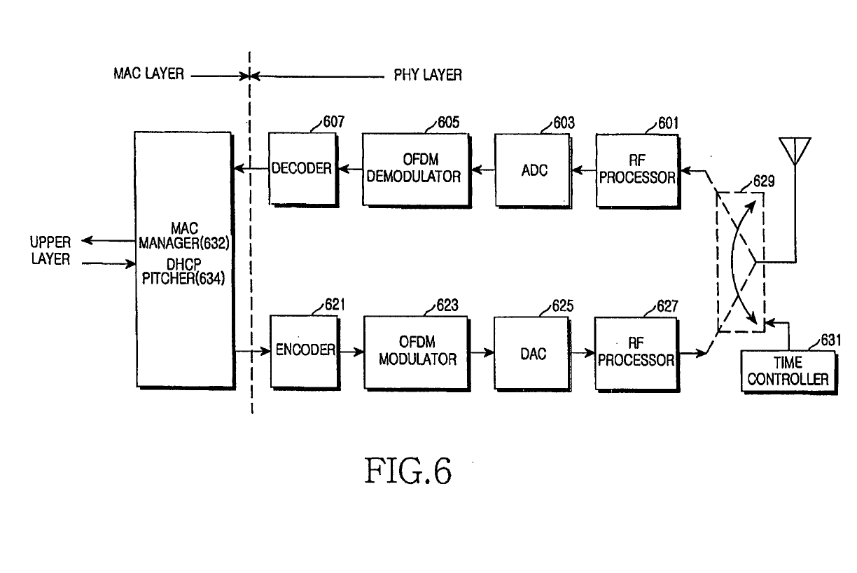

FIG. 6 is a block diagram of an IP address allocation apparatus in the IEEE 802.16e PCMCIA card according to an exemplary embodiment of the present invention.

Referring to FIG. 6, the IEEE 802.16e PCMCIA card includes a receiver, a transmitter, a MAC manager 632, a DHCP pitcher 634, a radio frequency (RF) switch 629, and a time controller 631.

The RF switch 629 switches an antenna to the transmitter or the receiver during a transmission or reception period under the control of the time controller 631 so that the transmitter and the receiver can share the antenna.

For example, the RF switch 629 connects the antenna to an RF processor 601 of the receiver under the control of the time controller 631 during reception. During transmission, the RF switch 629 connects the antenna to an RF processor 627 of the transmitter under the control of the time controller 631. The time controller 631 controls the switching operation of the RF switch 629 based on frame synchronization.

The receiver includes the RF processor 601, an analog-to-digital converter (ADC) 603, an OFDM demodulator 605, and a decoder 607.

The RF processor 601 downconverts an RF signal received through the antenna to a baseband analog signal. The ADC 603 converts the analog signal to sample data.

The OFDM demodulator 605 converts the time-domain sample data to frequency data by Fast Fourier transform (FFT).

The decoder 607 selects data on intended subcarriers from the frequency data and demodulates and decodes the frequency data at a predetermined Modulation and Coding Scheme (MCS) level. The decoded data is provided to the MAC manager 632 and the DHCP pitcher 634.

The transmitter includes an encoder 621, an OFDM modulator 623, a digital-to-analog converter (DAC) 625, and an RF processor 627.

The encoder 621 encodes and modulates a message received from the MAC manager 632 or the DHCP pitcher 634 at a predetermined MCS level.

The OFDM modulator 623 converts the encoded frequency signal received from the encoder 621 to time-domain sample data (i.e., an OFDM symbol) by Inverse Fast Fourier Transform (IFFT).

The DAC 625 converts the same data to an analog signal. The RF processor 627 upconverts the analog signal to an RF signal and transmits the RF signal through the antenna.

The MAC manager 632 and the DCHP pitcher 634 can be incorporated into the DD.

The MAC manager 632 performs a MAC layer (Layer 2 (L2)) operation in the IEEE 802.16e network system. It transmits data received from an upper later, and provides data received from the upper layer to the encoder 621. Particularly, the MAC manager 632 takes charge of network entry during an initial operation.

The DHCP pitcher 634 is allocated an IP address by a DHCP client function during an initial operation. That is, the DPCH pitcher 634 generates a DHCP message for IP address allocation to the encoder 621 and receives a DHCP message including an allocated IP address from the decoder.

As is apparent from the above description, the present invention can advantageously reduce the time required to complete a network connection by decreasing an IP address allocation time during an access to a BWA communication system.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for network address allocation in a terminal in a Broadband Wireless Access (BWA) communication system, the apparatus comprising:
an interface module for performing wireless communications through an antenna; and
a protocol controller for performing wireless communications using a predetermined protocol and performing a network address acquisition procedure during network entry.

2. The apparatus of claim 1, wherein the protocol controller is a device driver.

3. The apparatus of claim 1, wherein the protocol controller performs the network address acquisition procedure by a Dynamic Host Configuration Protocol (DHCP).

4. The apparatus of claim 1, wherein the network address acquisition procedure is performed by a predetermined value or user selection before booting of an operating system is completed.

5. A method for network address allocation in a terminal in a Broadband Wireless Access (BWA) communication system, the method comprising:
performing network entry by a protocol controller;
requesting network address allocation by the protocol controller, after the network entry;
being allocated a requested network address by the protocol controller; and
setting the allocated network address for a radio communication interface by the protocol controller.

6. The method of claim 5, wherein the protocol controller is a device driver.

7. The method of claim 5, wherein the network address requesting and allocation comprises requesting the network address and being allocated the network address by a Dynamic Host Configuration Protocol (DHCP).

8. The method of claim 5, wherein the network address allocation requesting comprises requesting the network address allocation by a predetermined value or user selection before booting of an operating system is completed.

9. A system for network address allocation in a Broadband Wireless Access (BWA) communication system, the system comprising:
a network device for communicating with another node by a predetermined protocol and allocating a network address, upon receipt of a network address allocation request; and
a terminal for performing wireless communications with the network device by the predetermined protocol and performing a network address acquisition procedure during network entry, through a protocol controller.

10. The system of claim 9, wherein the protocol controller is a device driver.

11. The system of claim 9, wherein the terminal performs the network address acquisition procedure by a Dynamic Host Configuration Protocol (DHCP) through the protocol controller.

12. The system of claim 9, wherein the terminal performs the network address acquisition procedure by a predetermined value or user selection before booting of an operating system is completed.
